(19) United States
(12) Patent Application Publication
(10) Pub. No.: US 2026/0187179 A1
(43) Pub. Date: Jul. 2, 2026

(54) CALCULATION MODEL AND CALCULATION PROGRAM

(71) Applicant: TDK CORPORATION, Tokyo (JP)

(72) Inventors: Tsuyoshi SUZUKI, Tokyo (JP); Kaito ASAI, Tokyo (JP)

(73) Assignee: TDK CORPORATION, Tokyo (JP)

(21) Appl. No.: 18/868,403

(22) PCT Filed: May 25, 2022
(86) PCT No.: PCT/JP2022/021466

§ 371 Date: Feb. 5, 2025

(51) Int. Cl. G06F 17/11

(52) U.S. Cl. CPC G06F 17/11

(57) ABSTRACT

This calculation model is a calculation model that is appliable to an Ising model or QUBO, in which a plurality of choices in a combinatorial optimization problem are assigned to any of possible values of one or more binary variables, and one of the binary variables is fixed on the basis of constraints imposed on the combinatorial optimization problem.

### TECHNICAL FIELD

The present invention relates to a calculation model and a calculation program.

### BACKGROUND ART

Attempts are being made to use quantum annealing to determine an optimal solution to a combinatorial optimization problem. The combinatorial optimization problem can be treated as a minimization problem that determines a combination that minimizes an arbitrary objective function.

Various constraint conditions may be imposed on an optimization problem. For example, as described in Patent Document 1, a constraint term may be added to an objective function so that the objective function is not minimized when the constraint conditions are violated.

### CITATION LIST

### Patent Document

Patent Document 1: PCT International Publication No. WO2022/024329

### SUMMARY OF INVENTION

### Technical Problem

As the number of constraint conditions increases, a proportion of a search range that satisfies the constraints decreases. Even if a constraint term is added to an objective function as a constraint condition, a range that does not satisfy the constraint condition is still searched, resulting in poor search efficiency.

The present invention has been made in consideration of the circumstances described above, and aims to provide a calculation model and a calculation program that have excellent search efficiency even when constraint conditions are imposed.

### Solution to Problem

The present invention provides the following devices to solve the problems described above.

A calculation model according to a first aspect is a calculation model applicable to an Ising model or QUBO. In this calculation model, a plurality of choices in a combinatorial optimization problem are assigned to one of possible values of one or more binary variables, and any one of the binary variables is fixed on the basis of a constraint provided to the combinatorial optimization problem.

In the calculation model according to the aspect described above, the variable that can be fixed on the basis of the constraint may be removed from a first calculation model represented by the following equation (1).

$$\begin{matrix}[ Math . 1 ] & \\ H = {\sum }_{i \neq j} {J}_{i , j} {x}_{i} {x}_{j} + {\sum }_{i} {h}_{i} {x}_{i} + α & ( 1 )\end{matrix}$$

However, in the equation (1), xᵢ and xⱼ are the binary variables, Jᵢⱼ is an interaction parameter, hᵢ is a parameter applied to each variable by an external factor, and a is a constant.

When applied to the QUBO, the calculation model according to the aspect described above may be represented by the following equation (2) when the fixable variable xₐ is fixed to 1, and may be represented by the following equation (3) when the fixable variable xₐ is fixed to 0.

$$\begin{matrix}[ Math . 2 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + J \text{?} ) x \text{?} + α + {h}_{a} & ( 2 )\end{matrix}$$

$$\begin{matrix}[ Math . 3 ] & \\ H = {\sum }_{i \neq j ∈ S \backslash \{ a \}} {J}_{i , j} {x}_{i} {x}_{j} + {\sum }_{i ∈ S \backslash \{ a \}} {h}_{i} x \text{?} + α & ( 3 )\end{matrix}$$

$$\text{?} \text{indicates text missing or illegible when filed}$$

When applied to the Ising model, the calculation model according to the aspect described above may be represented by the following equation (4) when the fixable variable xₐ is fixed to +1, and may be represented by the following equation (5) when the fixable variable xₐ is fixed to −1.

$$\begin{matrix}[ Math . 4 ] & \\ H = {\sum }_{\text{?}} {J}_{i , j} {x}_{i} {x}_{j} + {\sum }_{\text{?}} ( {h}_{i} + J \text{?} ) x \text{?} + α + {h}_{a} & ( 4 )\end{matrix}$$

$$\begin{matrix}[ Math . 5 ] & \\ H = {\sum }_{\text{?}} {J}_{i , j} {x}_{i} {x}_{j} + {\sum }_{\text{?}} ( {h}_{i} - J \text{?} ) x \text{?} + α - {h}_{a} & ( 5 )\end{matrix}$$

$$\text{?} \text{indicates text missing or illegible when filed}$$

In the calculation model according to the aspect described above, the constraint may be a constraint that a specific choice is selected among the plurality of choices.

In the calculation model according to the aspect described above, the constraint may be a constraint that a specific choice is not selected among the plurality of choices.

In the calculation model according to the aspect described above, each of the plurality of choices may be expressed in a one-hot expression.

In the calculation model according to the aspect described above, each of the plurality of choices may be expressed in a binary expression.

In the calculation model according to the aspect described above, each of the plurality of choices may be expressed in a domain wall expression.

In the calculation model according to the aspect described above, each of the plurality of choices may be expressed in a unary expression.

A calculation program according to a second aspect is a calculation program applicable to the Ising model or QUBO. This calculation program performs first processing of assigning a plurality of choices in a combinatorial optimization problem to one of possible values of one or more binary variables, and second processing of fixing any one of the binary variables on the basis of a constraint provided to the combinatorial optimization problem.

The second processing of the calculation program according to the aspect described above may include processing of determining a fixable variable among the binary variables on the basis of the constraint, and processing of removing the fixable variable from the first calculation model represented by the equation (1) shown above.

When applied to the QUBO, the calculation program according to the aspect described above may convert the equation (1) shown above into the equation (2) shown above when the fixable variable xₐ is fixed to 1, and convert the equation (1) shown above into the equation (3) shown above when the fixable variable xₐ is fixed to 0.

When applied to the Ising model, the calculation program according to the aspect described above may convert the equation (1) shown above into the equation (4) shown above when the fixable variable xₐ is fixed to +1, and convert the equation (1) shown above into the equation (5) shown above when the fixable variable xₐ is fixed to −1.

The calculation program according to the aspect described above may provide, as the constraint, a constraint that a specific choice is selected among the plurality of choices.

The calculation program according to the aspect described above may provide, as the constraint, a constraint that a specific choice is not selected among the plurality of choices.

The calculation program according to the aspect described above may express each of the plurality of choices in a one-hot expression.

The calculation program according to the aspect described above may express each of the plurality of choices in a binary expression.

The calculation program according to the aspect described above may express each of the plurality of choices in a domain wall expression.

The calculation program according to the aspect described above may express each of the plurality of choices in a unary expression.

### Advantageous Effects of Invention

The calculation model according to the present invention has excellent search efficiency.

### BRIEF DESCRIPTION OF DRAWINGS

FIG. 1 An image diagram of an Ising model and QUBO.

FIG. 2 An example which represents possible values of binary variables in a one-hot expression and in which a plurality of choices are assigned to these possible values.

FIG. 3 An example which represents possible values of binary variables in a binary expression and in which a plurality of choices are assigned to these possible values.

FIG. 4 An example which represents possible values of binary variables in a domain wall expression and in which a plurality of choices are assigned to these possible values.

FIG. 5 An example which represents possible values of binary variables in a unary expression and in which a plurality of choices are assigned to these possible values.

FIG. 6 An example of a case where a first constraint is imposed when a plurality of choices are assigned in a one-hot expression.

FIG. 7 An example of a case where a first constraint and a second constraint are imposed when a plurality of choices are assigned in a one-hot expression.

FIG. 8 An example of a conceptual diagram when a plurality of choices are assigned in a one-hot expression and a constraint that a specific choice is selected is provided.

FIG. 9 An example of a conceptual diagram when a plurality of choices are assigned in a one-hot expression and a constraint that a specific choice is not selected is provided.

FIG. 10 An example of a conceptual diagram when a plurality of choices are assigned in a one-hot expression and a constraint that a specific choice is not selected is provided.

FIG. 11 An example of a conceptual diagram when a plurality of choices are assigned in a one-hot expression and a constraint that a specific choice is not selected is provided.

FIG. 12 An example of a conceptual diagram when a plurality of choices are assigned in a binary expression and a constraint that a specific choice is not selected is provided.

FIG. 13 An example of a conceptual diagram when a plurality of choices are assigned in a domain wall expression and a constraint that a specific choice is not selected is provided.

FIG. 14 An example of a conceptual diagram when a plurality of choices are assigned in a domain wall expression and a constraint that a specific choice is not selected is provided.

FIG. 15 An example of a conceptual diagram when a plurality of choices are assigned in a unary expression and a constraint that a specific choice is not selected is provided.

FIG. 16 An example of a conceptual diagram when a plurality of choices are assigned in a unary expression and a constraint that a specific choice is not selected is provided.

### DESCRIPTION OF EMBODIMENTS

The present embodiment will be described in detail below with reference to the drawings as appropriate. The drawings used in the following description may show characteristic parts in an enlarged scale for a sake of convenience to make features of the present embodiment easier to understand, and dimensional ratios of each component may differ from actual ones. Materials, dimensions, and the like exemplified in the following description are merely examples, and the present invention is not limited thereto, and may be appropriately modified and implemented within a range not departing from a gist of the present invention.

### First Embodiment

A calculation model according to a first embodiment is a calculation model applicable to an Ising model or QUBO used in quantum annealing. Quantum annealing is an algorithm that determines a state (a ground state) with a minimum energy according to the calculation model.

The Ising model is a model that predicts a state that will be stable overall when a plurality of elements interact with each other and a force is provided to each element.

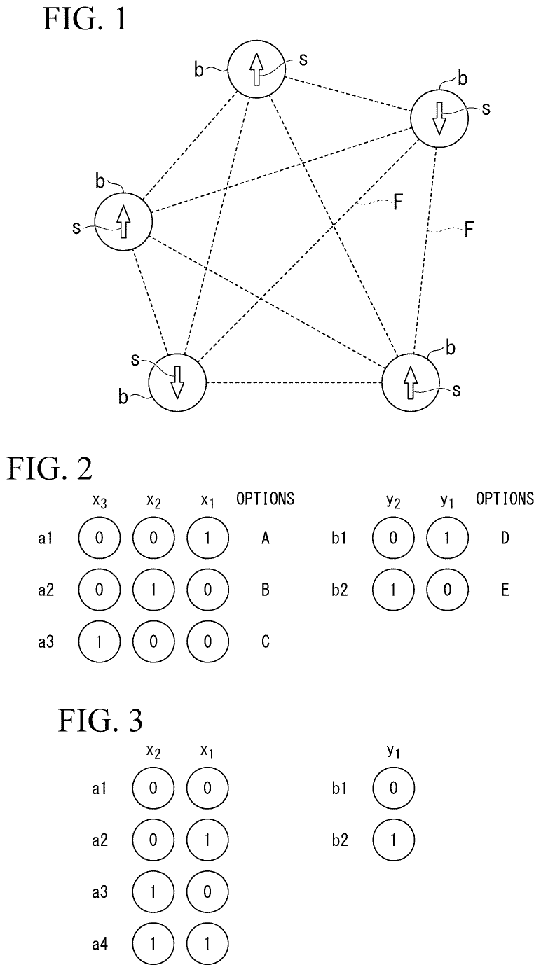

FIG. 1 is an image diagram of the Ising model. The Ising model has a plurality of bits b that interact with each other through a force F. Each bit b consists of spin s. The spin s indicates either an up or down state. Each bit b is represented by a variable that indicates a binary state. Depending on setting of the force F, a stable state may be a state in which adjacent spin s are in equilibrium, or a state in which they are antiparallel. The force F is called an interaction parameter.

The Ising model is represented by a following energy function (cost function).

$$\begin{matrix}[ Math . 6 ] & \\ H = {\sum }_{i \neq j} {J}_{i , j} {x}_{i} {x}_{j} + {\sum }_{i} {h}_{i} {x}_{i} + α & ( 1 )\end{matrix}$$

The calculation model represented by the equation (1) is hereinafter referred to as a first calculation model. xᵢ and xⱼ are input variables. xᵢ and xⱼ are binary variables of +1 or −1. xᵢ and xⱼ correspond to the state of spin s in FIG. 1. Jᵢⱼ is an interaction parameter. Jᵢⱼ corresponds to the force F in FIG. 1. hᵢ is a parameter applied to each bit b by an external factor, for example, a magnetic field parameter. The magnetic field parameter can be regarded as a weight for each bit b. α is a constant.

QUBO (Quadratic Unconstrained Binary Optimization) is a calculation model that can be converted into being equivalent to the Ising model. In the Ising model, each bit b is represented by a binary variable of +1 or −1, whereas each bit b is represented by a binary variable of 0 or 1 in the QUBO. Like the Ising model, the QUBO is represented by the first calculation model. In the QUBO, xᵢ and xⱼ are binary variables of 0 or 1.

The Ising model and QUBO can be applied to a combinatorial optimization problem. Examples of the combinatorial optimization problem include a traveling salesman problem, a knapsack problem, a shift optimization problem, and a delivery planning problem.

In the Ising model and QUBO, each of the plurality of choices in the combinatorial optimization problem is represented by combinations of binary variables xᵢ and xⱼ. Then, by determining the variables xᵢ and xⱼ that minimize the energy function, the combinatorial optimization problem can be solved using the Ising model or QUBO.

In the calculation model according to the present embodiment, the plurality of choices in the combinatorial optimization problem are assigned to one of possible values of one or more variables. The variables are the binary variables described above.

The plurality of choices in the combinatorial optimization problem differ depending on a problem for optimization. For example, in the traveling salesman problem, there are choices for which cities to go to and in what order. For example, in the shift optimization problem, there are choices for who will work and when.

These choices are assigned to the possible values of one or more variables. FIG. 2 shows an example in which a plurality of choices are assigned to any one of the possible values of variables. A left side of FIG. 2 shows that some of the plurality of choices are assigned to any one of the possible values of three variables, and a right side of FIG. 2 shows that some of the plurality of choices are assigned to any one of the possible values of two variables.

Here, the possible values of variables are selectable values from values that are generated by the combinations of binary variables. For example, as shown on a left side of FIG. 2, when there are three variables x₁, x₂, and x₃, each of the three variables x₁, x₂, and x₃ can select “1” or “0.” Therefore, there are eight possible values of the three variables x₁, x₂, and x₃: (0,0,0), (0,0,1), (0,1,0), (1,0,0), (0,1,1), (1,1,0), (1,0,1), and (1,1,1). These eight values are not all possible at all times, and the selectable values differ depending on an expression method of choices, which will be described later, and the possible values of the three variables x₁, x₂, and x₃ are further limited.

For example, when one of three choices A, B, and C is selected as a first choice, a choice A is assigned to a value a1, a choice B is assigned to a value a2, and a choice C is assigned to a value a3. Values a1, a2, and a3 are possible values of the variables x₁, x₂, and x₃, respectively, by the combinations of the variables. For example, when one of two choices D and E is selected as a second choice, these choices D and E are assigned to possible values of two variables y₁ and y₂. A choice D is assigned to a value b1, and a choice E is assigned to a value b2. Values b1 and b2 are possible values of the variables y₁ and y₂, respectively, by the combinations of the variables. In this case, the combination of choices that the calculation model can select as an optimal solution is one of (a1, b1), (a1, b2), (a2, b1), (a2, b2), (a3, b1), and (a3, b2). It is arbitrary which choices are assigned to which possible values of the variables.

The possible values of the variables are represented by combinations of a plurality of binary variables. For example, each of the values a1, a2, and a3 is expressed by combinations of three binary variables x₁, x₂, and x₃, and each of the values b1 and b2 is expressed by combinations of two binary variables y₁ and y₂. Each of the variables xᵢ, x₂, x₃, y₁, and y₂ corresponds to the variables xᵢ and xⱼ in the equation (1) and the spin s of the bit b in FIG. 1. FIG. 2 shows a case of QUBO, where the binary variables are 1 and 0. In a case of the Ising model, the binary variables may be +1 and −1.

Each of the choices may be expressed in a one-hot expression, a binary expression, a domain wall expression, or a unary expression.

The one-hot expression is a method of expressing N types of information with N variables. In a case of the one-hot expression, any one or only one of the N variables is “1,” and the other variables are all “0” in the case of QUBO and are all “−1” in the case of the Ising model. Each of the choices shown in FIG. 2 is represented in the one-hot expression. The one-hot expression requires variables as many as the number of choices, but even if one of the variables is rewritten by noise or the like, it does not represent another state, and is resistant to noise.

The binary expression is a method of expressing N types of information in binary numbers. In a case of the binary expression, each variable representing a choice is allowed to be “1” at the same time. FIG. 3 shows an example in which a plurality of choices are assigned to possible values of variables represented in the binary expression.

The binary expression can express many states with a small number of variables. For example, as shown in FIG. 3, even with two variables x₁ and x₂, four values a1 to a4 can be taken. For example, when the first choices are three of the choice A, the choice B, and the choice C, each of the choices A to C is assigned to one of the values a1 to a3, and a value a4 is left unassigned.

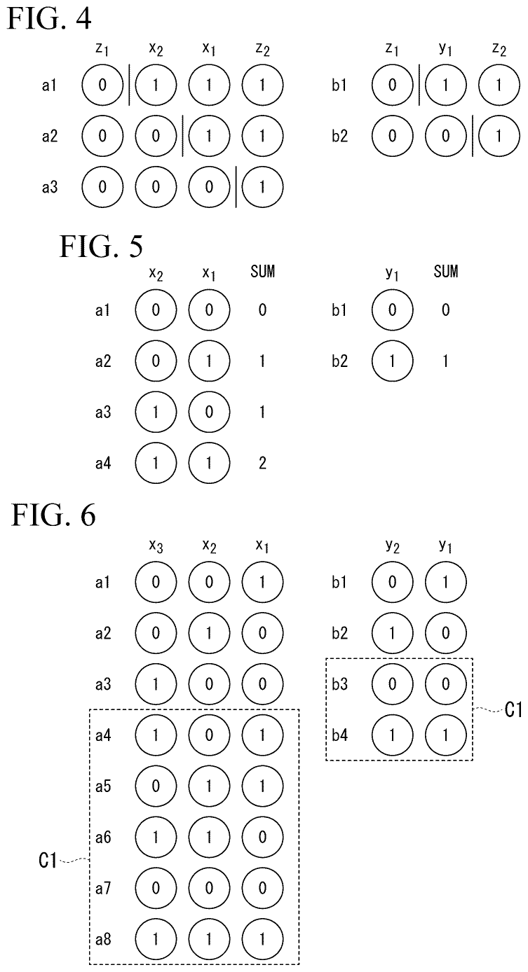

The domain wall expression is a method of expressing N types of information at a boundary position where adjacent values are different. FIG. 4 shows an example in which a plurality of choices are assigned to possible values of variables represented in the domain wall expression. In a case of the domain wall expression, each of the possible values a1, a2, and a3 of a variable is represented by two fixed values z₁ and z₂ and a plurality of variables xᵢ and x₂. One fixed value, z₂, is fixed to “1,” and the other fixed value, z₁, is fixed to “0” in the case of QUBO and to “−1” in the case of the Ising model.

The unary expression is a method of expressing N types of information by a sum of variables. FIG. 5 shows an example of possible values of variables represented in the unary expression. For example, when the first choices are three of the choice A, the choice B, and the choice C, the sum of the variables is assigned as 0 (the possible values of the variables are a1) for the choice A, as 1 (the possible values of the variables are a2 and a3) for the choice B, and as 2 (the possible values of the variables are a4) for the choice C.

The calculation model according to the present embodiment includes constraints. A computer calculates combinations that a human would exclude as equivalent to other combinations. Adding a constraint to a calculation model can prevent an impossible combination of variables that would result in a meaningless solution from being output as an optimal solution. Constraints include, for example, a constraint caused by an expression method of choices (hereinafter referred to as the first constraint), a constraint added to choices (hereinafter referred to as the second constraint), and the like.

The first constraint differs depending on the expression method of choices.

For example, when choices are expressed in a one-hot expression, the first constraint is a constraint that one of the variables is “1.”

For example, when choices are represented in the binary expression, the first constraint is a constraint that some of the possible values of the variables to which choices are not assigned are not selected. In the binary expression, the number of possible values of the variables may not match the number of choices, and some of the possible values of the variables may not have choices assigned.

For example, when choices are represented in the domain wall expression, the first constraint is a constraint that there is only one boundary where adjacent values are different.

For example, when choices are represented using the unary expression, the first constraint is not particularly imposed.

FIG. 6 shows an example of a case where a first constraint C1 is imposed on a state in which two or more variables can be expressed. In FIG. 6, the first constraint C1 is imposed assuming that the expression method of choices is the one-hot expression. In this case, the first constraint C1 is imposed on values a4 to a8, b3, and b4 among the possible values of the variables. The first constraint C1 ensures that an energy of an objective function is not minimized by combinations of these variables.

The values a4 to a8, b3, and b4 do not satisfy a condition of the one-hot expression, in which any one or only one of the N variables is “1,” and choices are not assigned thereto. Therefore, when the energy of the objective function is minimized for the values a4 to a8, b3, and b4, a meaningless solution will be output, so that the first constraint C1 is imposed on these values a4 to a8, b3, and b4.

The second constraint is a condition provided to the combinatorial optimization problem. For example, in the traveling salesman problem, the second constraint would be “it is essential to visit a city M in N^{th} place” or “it is essential not to visit a city M in N^{th} place.” In the shift optimization problem, the second constraints would be “not having the same person work more than a certain number of hours,” “specifying the number of employees per day,” and “reflecting vacation requests of each employee.”

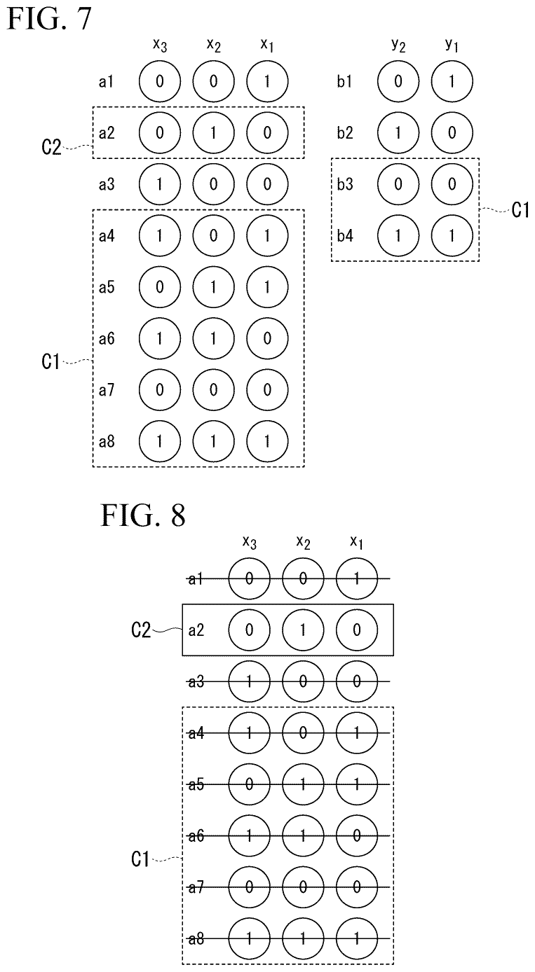

The second constraint is imposed within a range of conditions that satisfy the first constraint C1. FIG. 7 shows an example of a case where the first constraint C1 and the second constraint C2 are imposed on a state in which two variables can be expressed. The second constraint C2 is imposed on, for example, any one of the values a1 to a3, b1, and b2 that can be selected even under conditions where the first constraint C1 is imposed. For example, as shown in FIG. 7, the second constraint C2 is imposed on the value a2. For example, the second constraint C2 can be a constraint that the value a2 is selected, or a constraint that the value a2 is not selected. For example, when a constraint is imposed so that a2 is selected, the energy function represented by the equation (1) is minimized when a2 is selected. For example, when a constraint is imposed so that the value a2 is not selected, the energy function represented by the equation (1) is not minimized when the value a2 is selected.

One of methods for applying constraints to a calculation model is a penalty method. The penalty method is a method in which a constraint term is provided to prevent energy from being minimized for possible values of variables that produce solutions that cannot be selected (meaningless solutions). For example, the following equation is an example of an energy function in which a constraint term is added to an objective term using the penalty method.

$$\begin{matrix}[ Math . 7 ] & \\ H ( x ) = {H}_{cost} ( x ) + λ {H}_{penalty} ( x ) & ( 6 )\end{matrix}$$

In the equation (6) shown above, H_{cost}(x) is an objective term, H_{penalty}(x) is a constraint term, and λ is a coefficient. For example, by setting H_{penalty}(x) to a large value when both or either of the first constraint C1 and the second constraint C2 is not satisfied, an energy function H(x) is not minimized when both or either of the first constraint C1 and the second constraint C2 is not satisfied.

The penalty method prevents the energy function from being minimized when the possible values of variables a4 to a8, b3, and b4 do not satisfy the constraints.

In other words, even if a combination of choices that a calculation model can select is any one of (a1, b1), (a1, b2), (a2, b1), (a2, b2), (a3, b1), and (a3, b2), a search range of the calculation model is all combinations of (a1, b1), (a1, b2), (a2, b1). (a2, b2), (a3, b1), (a3, b2), (a4, b1), (a4, b2), (a5, b1), (a5, b2), (a6, b1), (a6, b2), (a7, b1), (a7, b2), (a8, b1), and (a8, b2).

In other words, (a4, b1), (a4, b2), (a5, b1), (a5, b2), (a6, b1), (a6, b2), (a7, b1), (a7, b2), (a8, b1), and (a8, b2) which do not need to be searched are included in the search range, and if all constraints are imposed using only the penalty method, search efficiency thereof will be poor.

In contrast, the calculation model of the present embodiment fixes any one of a plurality of binary variables on the basis of constraints provided to the combinatorial optimization problem. When some of the variables are fixed, the search range searched on the basis of the calculation model becomes narrower, which improves calculation efficiency. The variables that can be fixed in the calculation model differ depending on constraints provided to the calculation model.

First, the fixable variables are determined on the basis of the constraints imposed on the calculation model. Below, a method of determining a fixable variable in each of when the constraints imposed on the calculation model are a first pattern and a second pattern will be described.

The first pattern is a case where a constraint that a specific choice is selected among a plurality of choices is imposed on the calculation model. For example, in the traveling salesman problem, a constraint that determines “visit a city M in N^{th} place” and fixes the choice is provided to the calculation model.

In the first pattern, a specific choice is selected, so that any one of the values a1 to a3 is selected among the possible values of the variables. Values a4 to a8 cannot be selected among the possible values of the variables based on the first constraint C1.

For example, as shown in FIG. 8, a constraint that the value a2 is selected from values a1 to a8 (the choice B is selected) is provided. In this case, all of the variables xᵢ to x₃ can be fixed. For example, the variables x₁ to x₃ can be fixed to x₁=0, x₂=1, and x₃=0, respectively.

A constraint that fixes each of the variables x₁ to x₃ corresponds to the second constraint C2, but includes the first constraint C1. For this reason, when choices are selected based on a constraint, the first constraint C1 is unnecessary, and the constraints can be reduced. This can be also applied to a case where the choices are represented in the binary expression or the domain wall expression. When the choices are represented in the unary expression, the first constraint C1 is not imposed in the first place.

When the constraint that the value a2 is selected is provided in the first pattern, it is fixed that x₁=0, x₂=1, and x₃=0. In this case, x₂ is first removed from the first calculation model. The equation (1) is converted into an equation (2) as described below. In this case, a=2. In the equation (2), S/{a} means excluding a from a set S of all variable subscripts, a corresponds to a subscript of a fixed variable.

$$\begin{matrix}[ Math . 8 ] & \\ H = {\sum }_{\text{?}} {J}_{i , j} {x}_{i} {x}_{j} + {\sum }_{\text{?}} ( {h}_{i} + J \text{?} ) {x}_{i} + α + h \text{?} & ( 2 )\end{matrix}$$

$$\text{?} \text{indicates text missing or illegible when filed}$$

Next, x₁ is removed from the first calculation model. The equation (2) is converted into an equation (3) as shown below. In this case, a=1. In the equation (3), S/{a} means excluding a from a set S obtained by excluding 2 from the set of all variable subscripts.

$$\begin{matrix}[ Math . 9 ] & \\ H = {\sum }_{\text{?}} {J}_{i , j} {x}_{i} {x}_{j} + {\sum }_{\text{?}} h \text{?} {x}_{i} + α & ( 3 )\end{matrix}$$

$$\text{?} \text{indicates text missing or illegible when filed}$$

Next, x₃ is removed from the first calculation model. The equation (3) is converted again into an equation with a=3. In other words, in the equation (3), S/{a} means excluding a from a set S, which is obtained by excluding 2 and 1 from the set of all variable subscripts. In the example described above, the variables are removed in an order of x₂, x₁, and x₃, but the order is not limited to this. In this case, the search range of the calculation model is limited to (a2, b1) and (a2, b2). In other words, the calculation model according to the present embodiment can reduce the search range from 16 to 2 compared to the penalty method.

Here, as an example, a case where a constraint that the value a2 is selected (the choice B is selected) is provided is shown, but the same applies to cases where the value a1 is selected (the choice A is selected) and the value a3 is selected (the choice C is selected). When the value a1 is selected, the search range of the calculation model is limited to (a1, b1) and (a1, b2). When the value a3 is selected, the search range of the calculation model is limited to (a3, b1) and (a3, b2).

The second pattern is a case where a constraint that a specific choice is not selected among a plurality of choices is imposed on a calculation model. For example, in the case of the traveling salesman problem, a constraint that the choice indicating “visit a city M in N^{th} place” is not selected (that is, “not visit a city M in N^{th} place”).

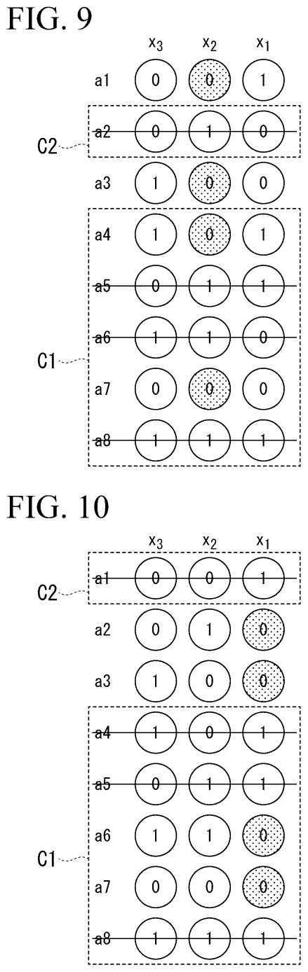

For example, as shown in FIG. 9, a constraint that the value a2 is not selected (the choice B is not selected) from the possible values a1 to a8 of the variables is provided. For example, when choices are represented in the one-hot expression, this constraint can be rephrased as a constraint that the possible value a1 of the variables or the possible value a3 of the variables is selected by combining it with the first constraint C1.

What is common between the possible value a1 of the variables and the possible value a3 of the variables is that the variable x₂ is 0. In other words, in this case, the fixable variable is x₂.

Next, the determined fixable variable is fixed, and the fixable variable is removed from the first calculation model represented by the equation (1) shown above.

In the second pattern, when a constraint that the value a2 is not selected is provided, x₂ is fixed to 0. In this case, the equation (1) is converted into the equation (3). In this case, a=2. In the equation (3), S/{a} means excluding a from the set S of all variable subscripts, a corresponds to a subscript of the fixed variable.

In this case, the search range of the calculation model is limited to (a1, b1), (a1, b2), (a3, b1), (a3, b2), (a4, b1), (a4, b2), (a7, b1), and (a7, b2). (a4, b1), (a4, b2), (a7, b1), and (a7, b2) are not selected by adding the first constraint C1 to the energy function as a constraint term. In other words, the calculation model according to the present embodiment can reduce the search range from 16 to 8 compared to the penalty method.

Here, as an example, a case where a constraint that the value a2 is not selected (the choice B is not selected) is provided is shown, but the search range of the calculation model can be restricted using a similar procedure even when a constraint that the value a1 is not selected (the choice A is not selected) is provided or when a constraint that the value a3 is not selected (the choice C is not selected) is provided.

For example, FIG. 10 shows an example where a constraint that the value a1 is not selected (the choice A is not selected) is provided. In this case, x₁ can be fixed to 0. In this case, the equation (1) is also converted into the equation (3) (where a=1). In this case, the search range of the calculation model is limited to (a2, b1), (a2, b2), (a3, b1), (a3, b2), (a6, b1), (a6, b2), (a7, b1), and (a7, b2). (a6, b1), (a6, b2), (a7, b1), and (a7, b2) are not selected by adding the first constraint C1 to the energy function as a constraint term.

For example, FIG. 11 shows an example where a constraint that the value a3 is not selected (the choice C is not selected) is provided. In this case, x₃ can be fixed to 0. Even in this case, the equation (1) is also converted into the equation (3) (where a=3). In this case, the search range of the calculation model is limited to (a1, b1), (a1, b2), (a2, b1), (a2, b2), (a5, b1), (a5, b2), (a7, b1), and (a7, b2). (a5, b1), (a5, b2), (a7, b1), and (a7, b2) are not selected by adding the first constraint C1 to the energy function as a constraint term.

As described above, the calculation model can narrow the search range by fixing any one of the plurality of binary variables on the basis of the constraints provided to the combinatorial optimization problem. When the search range of the calculation model is narrowed, the search efficiency of the calculation model increases and a calculation load decreases.

Up to this point, a case where any one of the variables x₁ to x₃ is fixed to 0 as the second pattern has been exemplified, but any one of the variables x₁ to x₃ may also be fixed to 1.

In this case, the equation (1) is converted into the equation (2), a corresponds to a subscript of the variable fixed to 1. In the equation (2), S/{a} means excluding a from the set S of all variable subscripts.

For example, when x₂ is fixed to 1, the search range of the calculation model is limited to (a2, b1), (a2, b2), (a5, b1), (a5, b2), (a6, b1), (a6, b2), (a8, b1), and (a8, b2). (a5, b1), (a5, b2), (a6, b1), (a6, b2), (a8, b1), and (a8, b2) are not selected by adding the first constraint C1 to the objective function as a constraint term.

Up to this point, a case where the choices are represented in the one-hot expression has been exemplified, but any one of the plurality of binary variables can be fixed using a similar procedure even when the choices are represented in other expressions.

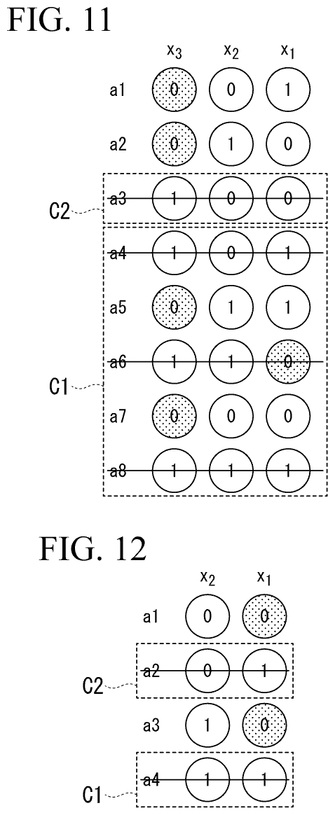

FIG. 12 shows an example of a fixing condition for variables when the choices are represented in the binary expression. For example, when a constraint that the value a2 is not selected is provided, xᵢ is fixed to 0. In this case, too, the equation (1) is converted into the equation (3) (where a=1). In this case, the search range of the calculation model is limited to (a1, b1), (a1, b2), (a3, b1), and (a3, b2). As shown in FIG. 12, the constraint that the value a2 is not selected also serves as the first constraint C1. In other words, the calculation model according to the present embodiment can reduce the search range from 8 to 4 compared to the penalty method.

FIG. 13 shows an example of a fixing condition for variables when the choices are represented in the domain wall expression. For example, a constraint that the value a1 is not selected is provided. In this case, x₂ is fixed to 0. Even in this case, the equation (1) is also converted into the equation (3) (where a=2). In this case, the search range of the calculation model is limited to (a2, b1), (a2, b2), (a3, b1), and (a3, b2). As shown in FIG. 13, the constraint that the value a1 is not selected also serves as the first constraint C1. In other words, the calculation model according to the present embodiment can reduce the search range from 8 to 4 compared to the penalty method.

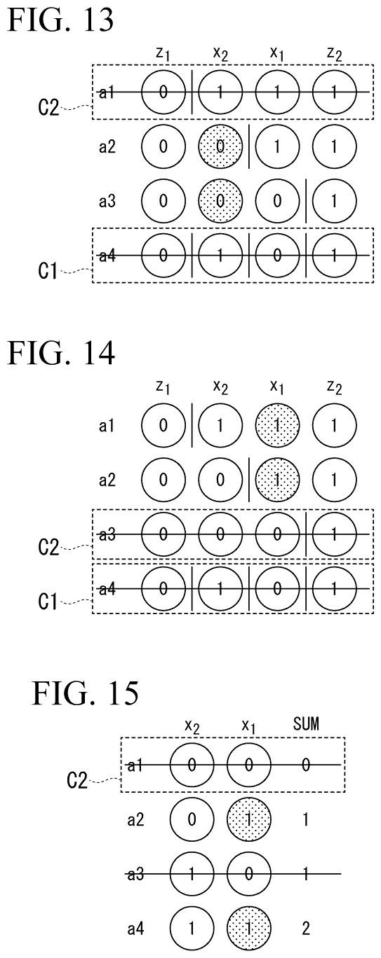

FIG. 14 shows an example of the fixing condition for variables when the choices are represented in the domain wall expression. For example, if a constraint that the value a3 is not selected is provided, x₁ is fixed to 1. In this case, the equation (1) is converted into the equation (2) (where a=1). In this case, the search range of the calculation model is limited to (a1, b1), (a1, b2), (a2, b1), and (a2, b2). As shown in FIG. 14, the constraint that the value a3 is not selected also serves as the first constraint C1.

FIG. 15 shows an example of a fixing condition for variables when the choices are represented in the unary expression. For example, when a constraint that the value a1 is not selected is provided, xⱼ is fixed to 1. In this case, the equation (1) is also converted into the equation (2) (where a=1). In this case, the search range of the calculation model is limited to (a2, b1), (a2, b2), (a3, b1), (a3, b2). In other words, the calculation model according to the present embodiment can reduce the search range from 8 to 4 compared to the penalty method. As another example, instead of fixing xᵢ to 1, x₂ may be fixed to 1.

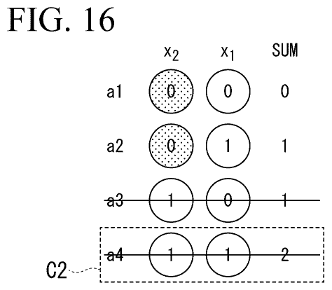

FIG. 16 shows an example of the fixing condition for variables when the choices are represented in the unary expression. For example, when a constraint that the value a3 is not selected is provided, x₂ is fixed to 0. In this case, the equation (1) is also converted into the equation (3) (where a=2). In this case, the search range of the calculation model is limited to (a1, b1), (a1, b2), (a2, b1), (a2, b2). As another example, instead of fixing x₂ to 0, x₁ may be fixed to 0.

Up to this point, a case where the binary variables are 1 or 0 when applied to the QUBO has been exemplified. In the case of the Ising model where the binary variables are represented as +1 or −1, the equation (1) is converted as follows.

For example, when the fixable variable xₐ is fixed to +1, the equation (1) is converted into the following equation (4).

$$\begin{matrix}[ Math . 10 ] & \\ H = {\sum }_{\text{?}} {J}_{i , j} {x}_{i} {x}_{j} + {\sum }_{\text{?}} ( {h}_{i} + J \text{?} ) {x}_{i} + α + h \text{?} & ( 4 )\end{matrix}$$

$$\text{?} \text{indicates text missing or illegible when filed}$$

For example, when the fixable variable xₐ is fixed to −1, the equation (1) is converted into the following equation (5).

$$\begin{matrix}[ Math . 1 ] & \\ H = {\sum }_{\text{?}} {J}_{i , j} {x}_{i} {x}_{j} + {\sum }_{\text{?}} ( {h}_{i} - J \text{?} ) {x}_{i} + α - h \text{?} & ( 5 )\end{matrix}$$

$$\text{?} \text{indicates text missing or illegible when filed}$$

This calculation model can be applied to an Ising machine specialized for calculation of the Ising model or QUBO. The calculation model is stored in the Ising machine as a calculation program. The calculation program provides instructions to a processor and makes the processor perform processing according to the calculation model. For example, quantum annealing machines (D-wave, NEC), coherent Ising machines (NTT), simulated bifurcation machines (Toshiba), digital annealers (Fujitsu), and CMOS annealers (Hitachi) are examples of the Ising machine.

The Ising machine may be a quantum gate type computer. For example, when a quantum approximate optimization algorithm (QAOA) is used, the Ising model or QUBO can be calculated by a quantum gate type computer.

The embodiments of the present invention have been described in detail with reference to the drawings. However, each configuration and combination thereof in each embodiment is merely an example, and addition, omission, substitution, and other modifications of the configuration can be made within a range not departing from the gist of the present invention.

### REFERENCE SIGNS LIST

b Bit
s Spin
F Force
a1 to a8, b1 to b4 Value
x₁ to x₃, y₁, y₂ Binary variables
A, B, C, D, E Choices
C1 First constraint
C2 Second constraint

1. A calculation model that is appliable to an Ising model or QUBO,
wherein a plurality of choices in a combinatorial optimization problem are assigned to any of possible values of one or more binary variables, and
one of the binary variables is fixed on the basis of constraints imposed on the combinatorial optimization problem.

2. The calculation model according to claim 1,
wherein a fixable variable is removed from a first calculation model represented by the following equation [1] on the basis of the constraint,
$$\begin{matrix}[ Math . 1 ] & \\ H = {\sum }_{i \neq j} {J}_{i , j} {x}_{i} {x}_{j} + {\sum }_{i} {h}_{i} {x}_{i} + α & ( 1 )\end{matrix}$$
here, in the equation (1), xᵢ and xⱼ are the binary variables, Jᵢⱼ is an interaction parameter, hᵢ is a parameter applied to each variable by an external factor, and α is a constant.

3. The calculation model according to claim 2,
wherein, when applied to the QUBO, the calculation model is represented by the following equation (2) when the fixable variable xₐ is fixed to 1, and
$$\begin{matrix}[ Math . 2 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + {J}_{i , a} ) {x}_{i} + α + {h}_{a} & ( 2 )\end{matrix}$$
is represented by the following equation (3) when the fixable variable xₐ is fixed to 0.
$$\begin{matrix}[ Math . 3 ] & \\ H = {\sum }_{i \neq j ∈ S \backslash \{ a \}} {J}_{i , j} {x}_{i} {x}_{j} + {\sum }_{i ∈ S \backslash \{ a \}} {h}_{i} {x}_{i} + α & ( 3 )\end{matrix}$$

4. The calculation model according to claim 2,
wherein, when applied to the Ising model, the calculation model is represented by the following equation (4) when the fixable variable xₐ is fixed to +1, and
$$\begin{matrix}[ Math . 4 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + {J}_{i , a} ) {x}_{i} + α + {h}_{a} & ( 4 )\end{matrix}$$
is represented by the following equation (5) when the fixable variable xₐ is fixed to −1.
$$\begin{matrix}[ Math . 5 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} - {J}_{i , a} ) {x}_{i} + α - {h}_{a} & ( 5 )\end{matrix}$$

5. The calculation model according to claim 1,
wherein the constraint is a constraint that a specific choice is selected among the plurality of choices.

6. The calculation model according to claim 1,
wherein the constraint is a constraint that a specific choice is not selected among the plurality of choices.

7. The calculation model according to claim 1,
wherein each of the plurality of choices is expressed in a one-hot expression.

8. The calculation model according to claim 1,
wherein each of the plurality of choices is expressed in a binary expression.

9. The calculation model according to claim 1,
wherein each of the plurality of choices is expressed in a domain wall expression.

10. The calculation model according to claim 1,
wherein each of the plurality of choices is expressed in a unary expression.

11. A calculation program that is applicable to an Ising model or QUBO, comprising:
first processing of assigning a plurality of choices in a combinatorial optimization problem to any one of possible values of one or more binary variables; and
second processing of fixing any one of the binary variables on the basis of a constraint provided in the combinatorial optimization problem.

12. The calculation program according to claim 11,
wherein the second processing performs processing of determining a fixable variable among the plurality of binary variables on the basis of the constraint and processing of removing the fixable variable from a first calculation model represented by the following equation [1],
$$\begin{matrix}[ Math . 6 ] & \\ H = {\sum }_{i \neq j} {J}_{i , j} {x}_{i} {x}_{j} + {\sum }_{i} {h}_{i} {x}_{i} + α & ( 1 )\end{matrix}$$
here, in the equation (1), xᵢ and xᵢ are the binary variables, Jᵢⱼ is an interaction parameter, hᵢ is a parameter applied to each variable by an external factor, and α is a constant.

13. The calculation program according to claim 12,
wherein, when applied to the QUBO, the equation (1) shown above is converted into the following equation (2) when the fixable variable xₐ is fixed to 1, and
$$\begin{matrix}[ Math . 7 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + {J}_{i , a} ) {x}_{i} + α + {h}_{a} & ( 2 )\end{matrix}$$
the equation (1) shown above is converted into the following equation (3) when the fixable variable xₐ is fixed to 0.
$$\begin{matrix}[ Math . 8 ] & \\ H = {\sum }_{i \neq j ∈ S \backslash \{ a \}} {J}_{i , j} {x}_{i} {x}_{j} + {\sum }_{i ∈ S \backslash \{ a \}} {h}_{i} {x}_{i} + α & ( 3 )\end{matrix}$$

14. The calculation program according to claim 12,
wherein, when applied to the Ising model, the equation (1) shown above is converted into the following equation (4) when the fixable variable xₐ is fixed to +1, and
$$\begin{matrix}[ Math . 9 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + {J}_{i , a} ) {x}_{i} + α + {h}_{a} & ( 4 )\end{matrix}$$
the equation (1) shown above is converted into the following equation (5) when the fixable variable xₐ is fixed to −1.
$$\begin{matrix}[ Math . 10 ] & \\ H = {\sum }_{i \neq j ∈ S \backslash \{ a \}} {J}_{i , j} {x}_{i} {x}_{j} + {\sum }_{i ∈ S \backslash \{ a \}} ( {h}_{i} + {J}_{i , a} ) {x}_{i} + α + {h}_{a} & ( 5 )\end{matrix}$$

15. The calculation program according to claim 11,
wherein a constraint is provided, as the constraint, to select a specific choice from the plurality of choices.

16. The calculation program according to claim 11,
wherein a constraint is provided, as the constraint, not to select a specific choice from the plurality of choices.

17. The calculation program according to claim 11,
wherein each of the plurality of choices is expressed in a one-hot expression.

18. The calculation program according to claim 11,
wherein each of the plurality of choices is expressed in a binary expression.

19. The calculation program according to claim 11,
wherein each of the plurality of choices is expressed in a domain wall expression.

20. The calculation program according to claim 11,
wherein each of the plurality of choices is expressed in a unary expression.
